(19) United States
(12) Patent Application Publication
(10) Pub. No.: US 2020/0329735 A1
(43) Pub. Date: Oct. 22, 2020

(54) EMULSION HEATING DEVICES AND METHODS

(71) Applicant: Société des Produits Nestlé S.A., Vevey (CH)

(72) Inventors: Kevin J. Cully, Chesterfield, MO (US); Michael John Saylock, KANSAS CITY, MO (US)

(21) Appl. No.: 16/841,291

(22) Filed: Apr. 6, 2020

Related U.S. Application Data
(60) Provisional application No. 62/835,643, filed on Apr. 18, 2019.

(51) Int. Cl. A23J 3/22; A23L 5/30; A23L 5/10

(52) U.S. Cl. CPC A23J 3/227; A23L 5/34; A23V 2002/00; A23L 5/13; A23L 5/15

(57) ABSTRACT

A texturized food analogue production system includes a first heating element, a second heating element, and a pump. The pump may be configured for moving a dough into the first heating element and across the second heating element. The second heating element includes a microwave applicator. A method for heating and protein texturization of a meat or non-meat dough includes heating the dough to a first temperature in a first heating element using shear heating and heating the dough to a second temperature using microwaves emitted from a second heating element.

### CROSS REFERENCE TO RELATED APPLICATIONS

This application claims priority to U.S. Provisional Application Ser. No. 62/835,643 filed Apr. 18, 2019 the disclosure of which is incorporated in its entirety herein by this reference.

### FIELD OF INVENTION

The present disclosure relates generally to methods and devices for making a food analogue. More specifically, the present disclosure relates to methods and devices for continuously forming food analogue chunks by preheating a dough prior to further heating of the dough.

### BACKGROUND

Conventional food analogue or chunk processes have several drawbacks. For example, steam oven processes are typically conducted at atmospheric pressure and temperatures below 100° C. and typically produce chunks with a reduced firmness and which lack an appearance of a real meat product. Insufficient firmness may limit the number of meat-like fibers and therefore can limit the number of forms for products produced using this technology. Further, steam oven processes may require a larger amount of floor space compared to other processes.

As another example, wet extrusion has limits to the range of fat content and moisture content that can be used. Typically, chunks have fat levels above 6% and moisture levels above 45%, which make the production of chunk products difficult using wet extrusion.

Other processes may rely on the use of shear heating. Shear heating can require the use of wheat gluten as a key functional ingredient to support texturization. Texturization may be defined as the creation of fibers or fiber-like structures within a composition (e.g. meat or non-meat dough). However, in recent years wheat gluten as an ingredient is avoided by some consumers, and instead many consumers are looking for chunk products that do not contain gluten or other cereal based proteins. Other ingredients may be used to replace wheat gluten, however, they either lack the structural strength to make a firm chunk or have negative impacts on the chunk palatability or chunk color.

### SUMMARY

The present disclosure provides advantages and solutions to problems with existing technologies for making food analogues. In this regard, a tubular microwave heating system may be combined with other heating techniques (e.g. shear heating) to produce meat or non-meat food analogues (or “chunks”) for natural chunk formulations. In order to reduce the cost of certain food products for consumers there has been a demand for products made from meat emulsions that resemble chunks or pieces of natural meat in appearance, texture, and physical structure, called “chunks,” “meat analogues” and/or “food analogues.” Such products may be used as a partial or complete replacement for more expensive natural meat chunks in food products such as stews, pot pies, casseroles, canned foods, and pet food products.

Chunky meat products may be highly desirable in human foods and pet foods, for aesthetic quality and consumer appeal. These chunky products can provide a more economical product which attempts to simulate natural meat chunks in shape, appearance, and texture. It can be highly desirable that these products retain their shape, appearance, and texture when subjected to commercial canning and retorting procedures.

Additionally, non-meat food analogues which typically obtain their protein source from plants may also be produced using the processes described herein.

Microwave heating systems may be used to produce meat analogues that do not contain wheat gluten, soy, and other cereal based proteins; however, current methods may be inconsistent or yield a product with suboptimal texturization. The methods and devices disclosed herein reduce or eliminate inconsistencies of the product and improve texturization.

Accordingly, in a general embodiment, the present disclosure provides a texturized food analogue production system comprising: a first heating element, a second heating element and a pump configured for moving a dough into the first heating element and across the second heating element. The first heating element comprises an emulsifier that heats the dough to a first temperature using shear heating and the second heating element heats the dough to a second temperature. The second heating element comprises a microwave applicator and the second temperature is higher than the first temperature.

Another aspect of the present disclosure provides a method for heating and protein texturization of a meat or non-meat dough comprising: directing the dough into a first heating element using a pump, wherein the first heating element comprises an emulsifier that heats the dough to a first temperature using shear heating and then heating the dough to a second temperature using microwaves emitted from a second heating element. The second temperature is higher than the first temperature.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIG. 1 illustrates a flowchart of an embodiment of a method for texturizing and shaping a processed food analogue according to the present disclosure.

FIG. 2 illustrates an embodiment of the processed food analogue according to the present disclosure.

FIG. 3 is a chart displaying various data relating to dough processing without any preheating of the dough.

FIG. 4 is a chart displaying various data relating to dough processing with preheating of the dough.

FIG. 5 illustrates a diagram of an embodiment of a system for producing a texturized food analogue according to the present disclosure.

FIG. 6 illustrates a top-view diagram of the embodiment of a system for producing a texturized food analogue shown in FIG. 5.

### DETAILED DESCRIPTION OF EXAMPLE EMBODIMENTS

Detailed embodiments of devices and methods are disclosed herein. However, the disclosed embodiments are merely exemplary of the devices and methods, which may be embodied in various forms. Therefore, specific functional details disclosed herein are not to be interpreted as limiting, but merely as a basis for the claims as a representative example for teaching one skilled in the art to variously employ the present disclosure.

As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

The terms food analogue, meat analogue and chunk generally refer to a product having a plurality of strands of interwoven fibers that are linearly arranged in cohesive, layered bundles. A meat analogue has a texture resembling the texture of meat. The texture is provided by cohesive, aligned fibers.

The term meat emulsion generally refers to a composition prepared by mixing, chopping and emulsifying a mixture of raw meat materials such as lean skeletal beef, pork, chicken, and/or meat by-products with ice or water and optionally other ingredients in such a manner as to produce an emulsion that contains fine fat particles coated with protein dissolved from meat ingredients. Heating the meat emulsion causes the protein to coagulate. This entraps the fat particles in the protein matrix thereby forming a firm meat emulsion. The resulting emulsion product is a uniform homogenous mass that contains no discrete meat particles. In some embodiments, a high-speed emulsifier or homogenizer is particularly suitable for emulsification. In some embodiments, the emulsion is prepared from frozen meat pieces or frozen ground meat and the emulsification is performed with the addition of heat in order to aid in the thawing of the frozen chunks and/or to thermally gel the emulsion.

The term dough, also known as meat batter, generally refers to a composition prepared by mixing an emulsion (e.g. meat emulsion) with functional dry ingredients. In some embodiments, the functional dry ingredients comprise texturizing ingredients such as wheat gluten, wheat flour, egg white, soy proteins, and/or pea proteins.

Protein is meant to include any protein from an animal or non-animal source. For example, animal proteins may originate from muscle meat, organs, and tendons of mammals, fowl or fish. Non-animal proteins may originate from vegetables, eggs, algal proteins, milk proteins, microbial proteins or insect proteins.

The term texturization refers to the development of an unstructured protein product into a structured protein product. Particularly, the conversion of an unstructured protein product with no visible grain or texture into a structured protein product with a definite shape having the consistency of cooked muscle meat.

The embodiments relate to methods and devices for continuously forming food analogue chunks by heating with electromagnetic radiation, including heating by dielectric heating such as by microwaves and radio frequency waves.

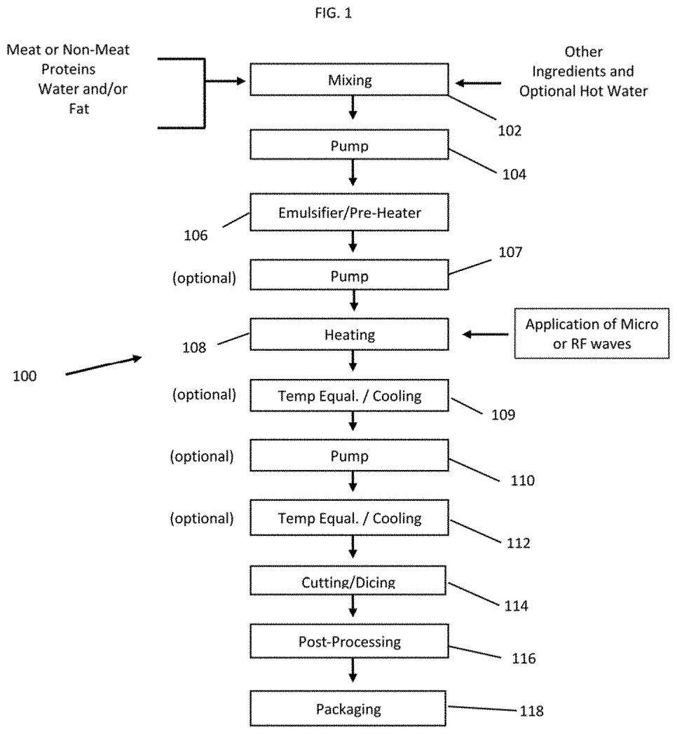

FIG. 1 generally illustrates an embodiment of a method 100 of continuous texturization and shaping of food analogues. In some embodiments, the steps are performed directly after each other without an intervening step, although some embodiments may include one or more intervening steps not included in the flowchart of FIG. 1. The method 100 may be performed without using extrusion, steam oven, thermal screw processing or heat exchangers.

In Step 102, ingredients such as a meat emulsion, non-meat proteins, liquids, and other dry ingredients can be mixed. For example, the ingredients may be mixed in a batch or continuous mixer. The ingredients may be mixed to form a composition. The composition can be partially or completely homogenized, homogenized meaning that a plurality of mixed ingredients are distributed substantially uniformly throughout the composition. In some embodiments, a meat emulsion is mixed with functional dry ingredients, such as wheat gluten or pea protein to form a dough. In an embodiment, the composition or dough is then fed, by a pump 104, into an emulsifier 106. In some embodiments, the pump is a vacuum pump/stuffer. In some embodiments the mixing step 102 comprises a screw conveyor that aids in the conveyance of the dough from a storage bin into the pump 104.

The emulsion may be prepared from at least one protein in water, for example a meat protein and/or a non-meat protein. Non-limiting examples of suitable meats include poultry, beef, pork, fish and mixtures thereof. Non-limiting examples of suitable non-meat proteins include wheat protein (e.g., whole grain wheat or wheat gluten such as vital wheat gluten), corn protein (e.g., ground corn or corn gluten), soy protein (e.g., soybean meal, soy concentrate, or soy isolate), rice protein (e.g., ground rice or rice gluten), cottonseed, peanut meal, pea protein, whole eggs, egg albumin, milk proteins, and mixtures thereof.

In some embodiments, the emulsion comprises from about 28% to about 60% protein. In some embodiments, the emulsion comprises from about 29% to about 40% protein. In one embodiment, the emulsion comprises from about 28% to about 33% protein.

In some embodiments, the emulsion comprises a non-meat protein, such as gluten (e.g., wheat gluten), and does not comprise a meat or a meat by-product. In other embodiments, the emulsion comprises a non-meat protein that does not include gluten and does not comprise any meat or meat by-products.

In some embodiments, the emulsion comprises from about 45% to about 80% moisture (e.g. water). In some embodiments, the emulsion comprises from about 48% to about 70% moisture. In another embodiment, the emulsion comprises about 50% to about 62% moisture. In one embodiment, the emulsion comprises from about 52% to about 56% moisture. The moisture content in the emulsion will depend on the amount of protein and fat in the meat emulsion.

In some embodiments, the emulsion does not contain a soy-based ingredient and/or does not contain a corn-based ingredient or another cereal-based ingredient (e.g., amaranth, barley, buckwheat, fonio, millet, oats, rice, wheat, rye, sorghum, triticale, or quinoa).

In one embodiment of step 102, the meat emulsion is mixed with a functional dry ingredient and additional water, fat and/or other optional ingredients. The functional dry ingredient can be wheat gluten, pea protein, whey or dried egg. Upon mixing of the meat emulsion with a functional dry ingredient, a dough is formed. In another embodiment of step 102, a non-meat protein is mixed with additional water, fat, and/or other optional ingredients to form a non-meat dough.

The dough may optionally comprise a flour. If flour is used, the flour may provide additional protein. Therefore, an ingredient may be used that is both a vegetable protein and a flour. Non-limiting examples of a suitable flour are a starch flour, such as cereal flours, including flours from rice, wheat, corn, barley, and sorghum; root vegetable flours, including flours from potato, cassava, sweet potato, arrowroot, yam, and taro; and other flours, including sago, banana, plantain, and breadfruit flours. Another non-limiting example of a suitable flour is a legume flour, including flours from beans such as favas, lentils, mung beans, peas, chickpeas, and soybeans.

In some embodiments, the dough comprises a meat and comprises gluten (e.g., wheat gluten). In alternative embodiments, the dough comprises a meat and does not comprise any gluten.

In some embodiments, the dough may comprise a fat such as an animal fat or a vegetable fat, or both. The fat source may be an animal fat source, such as chicken fat, tallow or grease. A vegetable oil, such as corn oil, sunflower oil, safflower oil, rape seed oil, soy bean oil, olive oil and other oils rich in monounsaturated and polyunsaturated fatty acids, may be used additionally or alternatively. In some embodiments, a source of omega-3 fatty acids is included, such as one or more of fish oil, krill oil, flaxseed oil, walnut oil, or algal oil.

In some embodiments, the dough comprises less than about 15% fat. In another embodiment, the dough comprises from about 2% to about 10% fat. In another embodiment, the dough comprises from about 4% to about 8% fat.

The dough may include other components in addition to proteins and flours, for example one or more of a vitamin, a mineral, a preservative, a colorant and a palatant.

Non-limiting examples of suitable vitamins include vitamin A, any of the B vitamins, vitamin C, vitamin D, vitamin E, and vitamin K, including various salts, esters, or other derivatives of the foregoing. Non-limiting examples of a suitable mineral include calcium, phosphorous, potassium, sodium, iron, chloride, boron, copper, zinc, magnesium, manganese, iodine, selenium, and the like.

Non-limiting examples of suitable preservatives include potassium sorbate, sorbic acid, sodium methyl para-hydroxybenzoate, calcium propionate, propionic acid, and combinations thereof. Non-limiting examples of a suitable colorant include FD&C colors, such as blue no. 1, blue no. 2, green no. 3, red no. 3, red no. 40, yellow no. 5, yellow no. 6, and the like; natural colors, such as roasted malt flour, caramel coloring, annatto, chlorophyllin, cochineal, betanin, turmeric, saffron, paprika, lycopene, elderberry juice, pandan, butterfly pea and the like; titanium dioxide; and any suitable food colorant known to the skilled artisan. Non-limiting examples of a suitable palatant include yeast, tallow, rendered animal meals (e.g., poultry, beef, lamb, and pork), flavor extracts or blends (e.g., grilled beef), animal digests, and the like.

In Step 106, additional mixing of the dough and preheating may occur. At least a portion of the preheating may be performed at the same time as the mixing of the dough in Step 106, as indicated in FIG. 1. Additionally or alternatively, at least a portion of the preheating may occur separately from Step 106, for example, before and/or after Step 106 is completed. In other words, the dough may be preheated prior to, after, and/or at any point in-between.

In some embodiments, the preheating using shear heating may occur at the same time as the mixing of the dough. When the preheating occurs at the same time as the mixing of the dough, the preheater may be incorporated into, or perform similar function to, an emulsifier. In some embodiments, the preheater is an emulsifier. Shear heating can result from viscous dissipation from an interaction between the dough and any walls or structure of the emulsifier. The dough may additionally or alternatively be preheated using conduction heating or steam injection heating. In an embodiment, the dough is preheated using any combination of shear heating, conduction heating, and steam injection heating. In some embodiments, the preheating will preheat the dough to a temperature greater than about 30° C. but less than about 80° C. In an embodiment, the preheating will preheat the dough to a temperature greater than about 32° C. but less than about 75° C. In an embodiment, the steam injection heating occurs in the emulsifier 106.

From Step 106, the dough may be pumped or otherwise transferred into a second heating element 108, for example a first heating chamber of a plurality of heating chambers. The pumping may be performed using an optional positive displacement pump 107. In an embodiment, the positive displacement pump is configured to pump the dough at high pressures, for example, about 2 bar or higher. For example, the dough may generally be pumped at pressures of about 6 bar to about 50 bar, about 8 bar to about 36 bar, or about 2 bar to about 25 bar into the heating chamber. The dough may also be pumped at pressures higher than 50 bar using suitable equipment. It is generally understood that the pressures referred to herein refer to the pressures read from the gauges and that the actual pressure may differ from the gauge reading.

In Step 108, the dough may be heated in the first heating chamber of the second heating element. In an embodiment, one or more of the plurality of heating chambers may be heated using microwave applicators or radio frequency electrodes. In an embodiment where the heating chambers are heated using microwave applicators or radio frequency electrodes, each of the heating chambers are defined by walls, an inlet to the heating chamber, and an outlet from the heating chamber. Each microwave applicator may be configured to attach to a waveguide. A waveguide may be configured to transmit microwaves from a microwave source to a corresponding applicator. A radio frequency source may be configured to transmit radio frequency waves to a corresponding pair of electrodes.

For example, the waveguide can transmit microwaves from a source by restricting the propagation of the waves substantially to one vector, thereby minimizing energy loss of the waves as the waves propagate from the microwave source to the applicator. A vector can be defined as any vector in a coordinate system (X, Y, Z), for example the vector (X=1, Y=0, Z=0). In an example, a microwave source may transmit microwaves using a waveguide. The waveguide may be configured to collect at least a portion of the microwaves and direct the waves in substantially a single vector to a destination. The destination may comprise an applicator. The applicator may then direct the microwaves to the first heating chamber to heat the dough. In some embodiments, one or more waveguides may transmit microwaves from a single source to multiple applicators.

The period of time required for the dough to be sufficiently texturized may depend on a number of factors, such as the temperature to which the dough is heated and the amount and type of protein in the dough. In some embodiments, the microwaves and/or the radio frequency waves heat the dough to a temperature of about 70° C. to about 166° C. or higher. In an embodiment, the pressure in the heating chamber may be maintained to control moisture flashing while having sufficient pressure to transfer the dough through the length of the chamber. The dough may be heated until texturization occurs, which may comprise the formation of fibers or fiber-like structure in the dough. After texturization, the dough may now be considered a chunk product, food analogue or meat analogue. The product can exit the second heating element into an exit manifold or a holding tube in which the product can optionally be cooled in Step 109 and/or Step 112, for example, the chunk product may be cooled to a temperature from about 20° C. to about 60° C.

In an embodiment, the dough can exit the first heating chamber of the second heating element and be directed to a second heating chamber associated with a second applicator. In other embodiments, the second heating element may comprise three or more heating chambers configured with applicators configured to successively receive the dough in each applicator's respective heating chamber. Two or more applicators can ensure that the dough is sufficiently texturized to form a firm chunk, food analogue or meat analogue product. In an embodiment with two or more applicators configured in series and where each applicator is associated with a respective heating chamber, the chunk product can exit the heating chamber of the last applicator in the series of applicators and into the exit manifold. Where two or more applicators are employed the applicators are typically positioned offset (e.g. equidistantly offset) from each other circumferentially. For example, in a system with two applicators the applicators are 180° offset relative to each other, with three applicators the applicators are offset 120° relative to each other, and with four applicators the applicators are offset 90° relative to each other.

The chunk product may exit the heating chamber through the use of an additional pump operating at the outlet of the second heating element, as shown in Step 110. The pump in Step 110 may be placed in other locations after the outlet of the last heating chamber of the second heating element in a direction of a flow of the chunk product. For example, Step 110 may be performed before or after the cooling/temperature equalization Step 109. In an embodiment, two temperature equalization/cooling steps can occur, a first one configured before the exit pump and a second one configured after the exit pump. The exit pump can control pressure at the exit of the second heating element to prevent uncontrolled moisture flashing and/or can provide pressure at the exit of the second heating element to push the hot product into and through the cooling device. Uncontrolled flashing can disrupt the structure of the texturized food product resulting in a food product with unacceptable texture (e.g. crumbly)

The flow in the exit manifold can optionally be restricted in Step 109. For example, a section of piping through which the chunk product is directed can have a decreasing cross sectional flow area along the length of the section of piping. The decreasing cross sectional flow area may restrict the flow of the chunk product.

The restricted flow can provide sufficient back pressure to maintain a consistent operating pressure. By maintaining a consistent system pressure, the process can remain more stable, particularly at elevated temperatures above about 100° C. Process stability may be maintained, and the quality of the appearance, texture, and physical structure of the final product can be ensured by controlling one or more of: (a) the formulation of the emulsion and/or dough, (b) the flow rate and consistency of the flow, (c) the rate of heating, (d) the amount of moisture and fat release during the heating, and (e) the system back pressure.

After passing through the exit manifold, the chunk product, food analogue or meat analogue may be resized or cut into shapes by using a cutting die (i.e., a die with a sharp leading edge facing the product flow) in Step 114. In addition, the cutting die may be cooled to reduce the temperature to avoid rapid expansion of the resultant product. Rapid expansion of the product may increase the amount of undesirable chunk fines (small pieces). Additionally or alternatively, a rotary knife or another type of cross-cut knife may be used to reduce the size (e.g., the length) of the product to a predetermined size or a predetermined range of sizes. In some embodiments, cutting blades may be incorporated within the exit manifold downstream from the second heating element.

After the optional resizing in Step 114, the product may undergo post-processing in Step 116. For example, the product may be mixed with other ingredients, for example, ingredients to make a gravy (e.g., a starch and/or a gum in water), a broth (comprising ingredients that have been simmered), vegetables (e.g., potatoes, squash, zucchini, spinach, radishes, asparagus, tomatoes, cabbage, peas, carrots, spinach, corn, green beans, lima beans, broccoli, Brussels sprouts, cauliflower, celery, cucumbers, turnips, yams and mixtures thereof), condiments (e.g., parsley, oregano, and/or spinach flakes), or kibbles, or any combination thereof.

In Step 118, the product may be placed in a package (alone or in combination with the other ingredients). Non-limiting examples of a suitable package include a can, a pouch, a glass container, or a plastic container. In some embodiments, the product may be filled into packages and then retorted or pasteurized. Typically, a retorting temperature of about 118° C. to about 121° C. for about 40 minutes to about 90 minutes is satisfactory in producing a commercially sterile product. In some embodiments, the product is frozen or dehydrated.

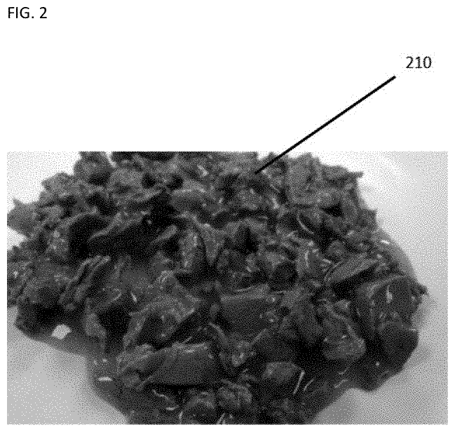

FIG. 2 illustrates an exemplary embodiment of a processed food analogue 210 containing about 10% whey and about 20% dried egg.

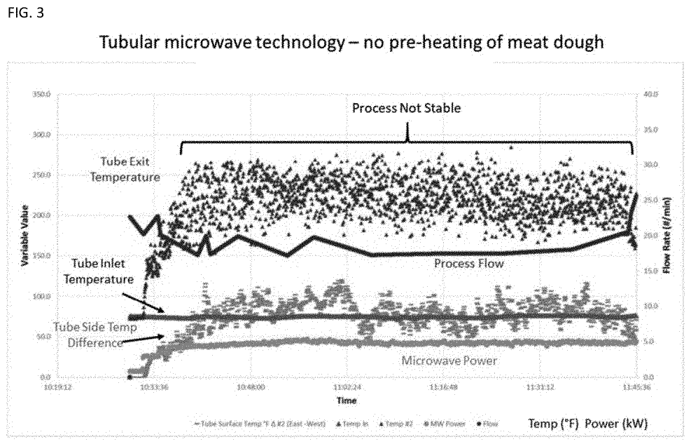

FIG. 3 is a chart displaying data relating to dough processing without any preheating of the dough. Stated otherwise, the data related to dough processing of FIG. 3 is from a comparative process in which the preheating of Step 106 according to the method 100 has been omitted.

In the comparative process associated with FIG. 3, a dough enters a tube inlet and a tube inlet temperature is recorded. The dough is then directed through the tube to an outlet of the tube. As the dough is directed through the tube, the dough may contact a tube side with a side temperature. A tube side temperature difference can then be recorded, where the tube side temperature difference is the difference between two circumferentially offset points on the tube side at a single time point in the process. Finally, as the dough exits the tube at the outlet of the tube an exit temperature can be recorded. In addition, a process flow rate (“Process Flow” in FIG. 3) and a microwave power level (“Microwave Power” in FIG. 3) may be recorded and are shown in FIG. 3. The X-axis is time. Notably, the inlet temperature is approximately constant in FIG. 3, as is the microwave power level. However, the tube side temperature difference and the tube exit temperature are highly variable in this comparative process. Variable tube side temperature difference and tube exit temperature can result in a sub-optimal chunk product in this comparative process.

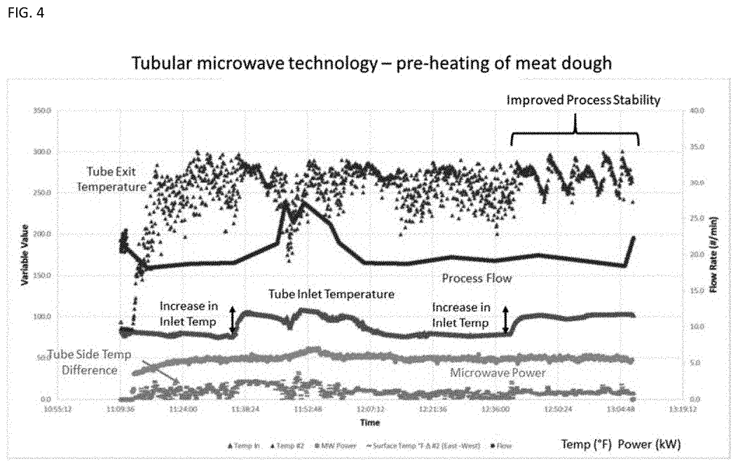

In contrast, FIG. 4 is a chart displaying the data relating to dough processing with preheating of the dough. The chart of FIG. 4 displays various recorded parameters of a method 100 as described in the process of FIG. 1, but unlike the comparative process of FIG. 3, includes the preheating Step 106 of the method 100 that was omitted from the method represented in the chart of FIG. 3. As in FIG. 3, the tube inlet temperature, the tube side temperature difference, the tube exit temperature, the microwave power level, and the process flow rate can be recorded.

The inlet temperature is again approximately constant in FIG. 4, as is the microwave power level. The increased inlet temperature is shown and labeled in FIG. 4. However, in contrast to the method with no preheating shown in FIG. 3, the tube side temperature difference and the tube exit temperature shown in FIG. 4 are more stable. Stability may be defined as the variability between successive data points along the Y-axis of FIGS. 3 and 4. The more consistent or stable tube side temperature difference and tube exit temperature can result in an optimal product and/or more consistent production of the product.

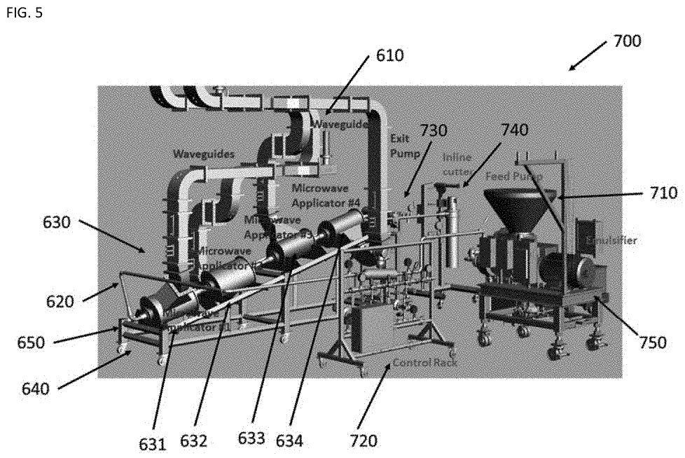

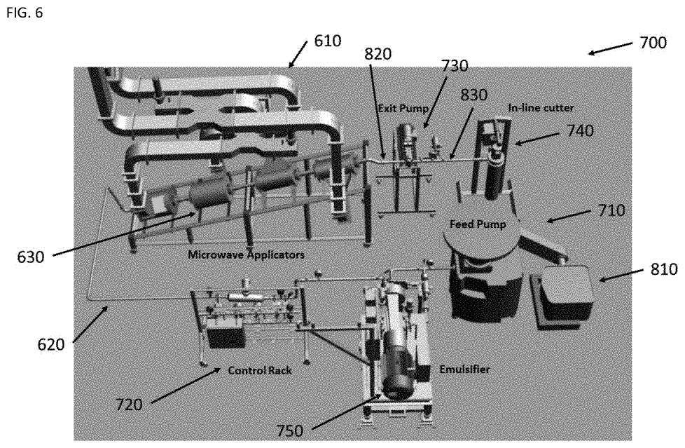

FIGS. 5 and 6 illustrate a diagram of an exemplary embodiment of a system 700 comprising devices for texturizing and shaping a food analogue product according to the present disclosure. The dough can enter a feed pump 710 and can be directed to an emulsifier 750. The dough can be processed at the emulsifier 750 to ensure that the ingredients of the processed food analogue 210 are homogenously mixed.

The dough may be preheated in the emulsifier 750. Preheating may occur before, during and/or after any processing that may occur in the emulsifier 750. The dough may be preheated using shear heating, which can be a result of viscous dissipation from an interaction between the dough and any walls or structure of the emulsifier. The preheating may occur in a separate structure from the emulsifier, for example preheating may occur in a preheater. The dough may be preheated using conduction heating and/or steam injection heating. The preheater may be a conduction heating device and/or steam injection heating device. In an embodiment, the dough is preheated using any combination of shear heating, conduction heating, and steam injection heating. The dough may be preheated to a temperature from about 30° C. to about 80° C. In an embodiment, the dough may be preheated to a temperature from about 32° C. to about 75° C.

After the dough is homogenously mixed and preheated, the dough can pass through a control rack 720. The control rack 720 can measure a temperature and a pressure of the emulsion to use for data collection or data validation. The control rack 720 can control the other sub-systems of the system 700. In one example, the control rack 720 may be configured to control any pump connected to the system 700. For example, the control rack 720 may control the pump of Step 107 to increase flow through the microwave applicators 630.

The dough can be directed through the feed line 620 to the first microwave applicator 631. Microwave energy may be directed from the waveguide system 610 into the microwave applicators 630 including the first microwave applicator 631. Heat can be transferred to the dough from the first microwave applicator 631 from a first direction as the dough passes through the microwave chamber of the first microwave applicator 631.

The dough can then be directed to a second microwave applicator 632, which can also receive microwave energy from the waveguide system 610. Heat can be transferred to the dough from the second microwave applicator 632 from a second direction. In the exemplary embodiment shown in FIGS. 5 and 6, the second direction is established by the direction in which the second microwave applicator 632 connects to the microwave chamber and moving in a counterclockwise manner is about 90° offset with respect to the first microwave applicator 631.

The dough can then be directed to a third microwave applicator 633, which can also receive microwave energy from the waveguide system 610. Heat can be transferred to the dough from the third microwave applicator 633 from a third direction. In the exemplary embodiment shown in FIGS. 5 and 6, the third direction is established by the direction in which the third microwave applicator 633 connects to the microwave chamber and continuing to move in a counterclockwise manner is about 90° offset with respect to the second microwave applicator 632 and about 180° offset with respect to the first microwave applicator 631.

The dough can then be directed to a fourth microwave applicator 634, which can also receive microwave energy from the waveguide system 610. Heat can be transferred to the dough from the fourth microwave applicator 634 from a fourth direction. In the exemplary embodiment shown in FIGS. 5 and 6, the fourth direction is established by the direction in which fourth microwave applicator 634 connects to the microwave chamber and continuing to move in a counterclockwise manner is about 90° offset relative to the third microwave applicator 633, 180° offset relative the second microwave applicator 632 and 270° offset relative to the first microwave applicator 631.

The microwave applicators in the second heating element are generally positioned circumferentially offset, with respect to each other. For example, the second heating element can comprise two microwave applicators each applicator connected to a separate microwave heating chamber. In the embodiment comprising two microwave applicators, the applicators can be configured 180° offset from each other. In an embodiment, the second heating element can comprise three microwave applicators each applicator connected to a separate microwave heating chamber. In the embodiment comprising three microwave applicators, the applicators can be configured 120° offset from each other. In an embodiment, the second heating element can comprise four microwave applicators, each applicator connected to a separate microwave heating chamber. In the embodiment comprising four microwave applicators, the applicators can be configured 90° offset relative to each other. The result of the spacing of microwave applicators is a distribution of the microwave energy such that the product exiting the second heating element is more uniformly heated and with a reduction or elimination of hotspots and/or product charring.

The resultant food analogue product, meat analogue product or chunk product can be directed out of an exit pump 730 and to an inline cutter 740. The product may be then cut by the inline cutter 740 into various lengths, strips or patterns as desired. When the dough has been processed by the presently illustrated system, the dough may substantially form the processed food analogue, meat analogue or chunk 210.

As shown in FIG. 6, in the system 700 the dough can be stored in a bin 810 prior to processing. The dough may then be transferred from the bin 810 to the feed pump 710 and then to the emulsifier 750.

FIG. 6 illustrates a first cooling location 820 and a second cooling location 830. The system 700 may optionally include a cooler or a retainer for the food analogue 210, each optionally located at the first cooling location 820 and/or the second cooling location 830. During a cooling or a retention of the food analogue 210, both a temperature and a pressure of the food analogue 210 can be gradually reduced. In an embodiment, the food analogue 210 undergoes a decrease in pressure at a predetermined rate in a cooling device and/or is subjected to a predetermined final pressure after flowing from the microwave applicators 630.

### Example

A meat analogue product was produced using the methods describe herein. A meat emulsion including ground meat protein (50%), dried egg powder (20%), whey protein concentrate (10%), plus additional ingredients were mixed in a batch mixer. The composition was pumped into an emulsifier and pre-heated to about 38° C. using shear heating. The dough was transferred to a second heating element and heated to a temperature from about 140° C. to about 165° C. The second heating element comprised two microwave heating chambers sequentially configured, with the microwave applicator for each heating chamber configured, circumferentially, 180° apart. The meat analogue product was pumped into a cooling/temperature equalization tube. The product was cut offline with a standard dicing machine. The resultant product is shown in FIG. 2.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims. Further, the present embodiments are thus not to be limited to the precise details of methodology or construction set forth above as such variations and modification are intended to be included within the scope of the present disclosure. Moreover, unless specifically stated any use of the terms first, second, etc. do not denote any order or importance, but rather the terms first, second, etc. are merely used to distinguish one element from another.

What is claimed is:

1. A texturized food analogue production system comprising:
a first heating element;
a second heating element; and
a pump configured for moving a dough into the first heating element and across the second heating element;
wherein the first heating element comprises an emulsifier that heats the dough to a first temperature using shear heating;
wherein the second heating element heats the dough to a second temperature, the second heating element comprising a microwave applicator; and
wherein the second temperature is higher than the first temperature.

2. The system according to claim 1, wherein the second heating element comprises an array of microwave applicators.

3. The system according to claim 1 wherein the first heating element heats the dough to a temperature from about 32° C. to about 75° C.

4. The system according to claim 1, wherein the second heating element heats the dough to a temperature from about 70° C. to about 166° C.

5. The system according to claim 1, wherein the first heating element further comprises a steam injection heating element.

6. The system according to claim 1, wherein the second heating element is configured to apply heat to the dough under a pressure that is greater than atmospheric pressure.

7. The system according to claim 6, wherein the pressure is from about 2 bar to about 25 bar.

8. The system according to claim 1, further comprising an inline cutter positioned downstream of the second heating element.

9. The system according to claim 1, wherein the system does not comprise an in-line or static mixer.

10. The system according to claim 1, wherein the system does not comprise a heat exchanger.

11. A method for heating and protein texturization of a meat or non-meat dough comprising:
directing the dough into a first heating element using a first pump;
heating the dough to a first temperature, using the first heating element, wherein the first heating element comprises an emulsifier that heats the dough to the first temperature using shear heating; and
heating the dough to a second temperature using microwaves emitted from a second heating element, wherein the second temperature is higher than the first temperature.

12. The method according to claim 11, wherein the dough does not contain wheat gluten.

13. The method according to claim 11, wherein the dough does not contain cereal.

14. The method according to claim 11, further comprising a cooling step after the heating the dough to a second temperature.

15. The method according to claim 11, wherein the first temperature is from about 32° C. to about 75° C.

16. The method according to claim 11, wherein the second temperature is from about 70° C. to about 166° C.

17. The method according to claim 11, wherein the first heating element further comprises steam injection heating.

18. The method according to claim 11, comprising a reduction of pressure after the dough is heated by the second heating element.

19. The method according to claim 18, wherein the reduction of pressure is controlled with a second pump configured after the second heating element.

20. The method according to claim 11, wherein the heated dough is a meat analogue.
